(19) United States
(12) Patent Application Publication
(10) Pub. No.: US 2009/0273895 A1
(43) Pub. Date: Nov. 5, 2009

(54) PORTABLE TERMINAL DEVICE

(75) Inventor: Chitose SAKAGUCHI, Kanagawa-ken (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/366,696

(22) Filed: Feb. 6, 2009

(30) Foreign Application Priority Data
Apr. 30, 2008 (JP) P2008-118544

(51) Int. Cl. G06F 1/16; G08B 29/00

(52) U.S. Cl. 361/679.27; 726/34

(57) ABSTRACT

A portable terminal device includes first input receiving unit provided in a first casing receiving input if the device is opened to expose the first input receiving unit, first displaying unit provided in a second casing turning-on if the device is opened to expose the first displaying unit, second input receiving unit receiving input if the device is closed to expose the second input receiving unit, turning-on lock unit for controlling the first displaying unit in a turning-on impossible state on the basis of a lock set instruction input received by the first input receiving unit or the second input receiving unit, and lock canceling unit for controlling the first displaying unit in a turning-on possible state on the basis of a lock cancel instruction input received by the second input receiving unit if the first displaying unit is controlled in a turning-on impossible state by the turning-on lock unit.

### BACKGROUND OF THE INVENTION

1. Field of the Invention

The present invention relates to portable terminal devices, and in particularly, to a portable terminal device having one or more lock functions.

2. Description of the Related Art

Recently, in portable terminal devices, such as mobile phones, increasing devices have multiple functions of not only voice communication but also data communication, picking up moving images, moving audio-visual functions, and access to documents and images. Hence, the portable terminal devices have been provided with various configurations putting emphasis on operationality during using these various functions. In these portable terminal devices, in order to strike a balance between the operationality, during the voice communication and the operation using operating keys, and the demand for the device miniaturizing, foldable portable terminal devices composed of two casings connected together have been provided.

In foldable portable terminal devices, opened/closed states are switched about a hinge mechanism. In the opened state of the device, main operating keys provided on one casing for receiving various inputs and a main display provided on the other casing to occupy a large portion of the casing are accessibly exposed for various operations. In the closed state of the device, the main operating keys and the main display provided in the respective casings are overlapped with each other to have a compact state of the portable terminal device.

In the foldable portable terminal device, in order to execute part of operations even in the closed state, a sub-display and sub-operating keys are provided on the surfaces of the casings. The sub-display is smaller than the main display in size, on which the present time, the battery residual power, and information of the received voices and mails, for example, are displayed. The number of the sub-operating keys is smaller than that of the main operating keys, and outgoing call and simple inputs, for example, can be made with the sub-operating keys.

In the portable terminal device, for preventing a third party from using the device and the accidental improper operation generated when storing the device in a bag, for example, a key lock function is provided for invalidating the operation received from operating keys (see Japanese Unexamined Patent Application Publication No. 2005-347986).

On the other hand, a portable terminal device has been known in that the turning-on/off states of the main display of the device are preferably controlled for improving the usability of the device (see Japanese Unexamined Patent Application Publication No. 2005-354544).

The portable terminal device has various functions, and along with this, the level of importance is increased in security enhancement against the abuse of a third party and control of the information contained within the device.

In the portable terminal device described in Japanese Unexamined Patent Application Publication No. 2005-347986, there is provided a lock function being preferably settable/resettable in accordance with opened/closed states. However, the lock function is not yet considered for operations executable in the respective opened/closed states. As a result, various functions simply executable in the closed state using the smaller number of operating keys in comparison, with the main display and main operating keys have not been sufficiently used.

In the portable terminal device described in Japanese Unexamined Patent Application Publication No. 2005-354544, the turning-on/off states of the main display are preferably controlled; however, the lock function for security is not provided.

### SUMMARY OF THE INVENTION

The present invention has been accomplished in view of the above circumstances, and an objection of the invention is to provide a portable terminal device capable of improving the security enhancement against the abuse of a third party and maintaining operationality for users by controlling the turning-on state of a main display.

This and other objects can be achieved according to the present invention by providing a portable terminal device according to the present invention includes a first casing; a second casing connected rotatably with the first casing to have an opened state and closed state; a first input receiving unit provided in a first casing to receive an input if the portable terminal device is the opened state to expose the first input receiving unit; a first displaying unit provided in a second casing to be turned-on if the portable terminal device is the opened state to expose the first displaying unit; a second input receiving unit provided in the first casing or the second casing to receive an input if the portable terminal device is the closed state to expose the second input receiving unit; a turning-on lock unit for controlling the first displaying unit in a turning-on impossible state on the basis of a lock set instruction input received by the first input receiving unit or the second input receiving unit; and lock canceling unit for controlling the first displaying unit in a turning-on possible state on the basis of a lock cancel instruction input received by the second input receiving unit if the first displaying unit is controlled in the turning-on impossible state by the turning-on lock unit.

The portable terminal device according to the present invention can improve the security enhancement against the abuse of a third party and maintain the operationality for users by controlling the turning-on state of the main display.

### BRIEF DESCRIPTION OF THE DRAWINGS

FIG. 1 is an external perspective view of a portable terminal device according to the present invention, showing an opened state of the device;

FIG. 2 is an external perspective view of the portable terminal device according to the present invention, showing a closed state of the device;

FIG. 3 is a drawing showing the internal configuration of a portable terminal device according to an embodiment;

FIG. 4 is a flowchart of main-display turning-on lock processing to be executed in the portable terminal device according to the embodiment;

FIG. 5 is a drawing showing a display example on a sub-display of the portable terminal device according to the embodiment; and

FIG. 6 is a flowchart of turning-on lock/key lock processing to be executed in the portable terminal device according to the embodiment.

### DESCRIPTION OF THE PREFERRED EMBODIMENTS

Embodiments of a portable terminal device according to the present invention will be described with reference to the attached drawings.

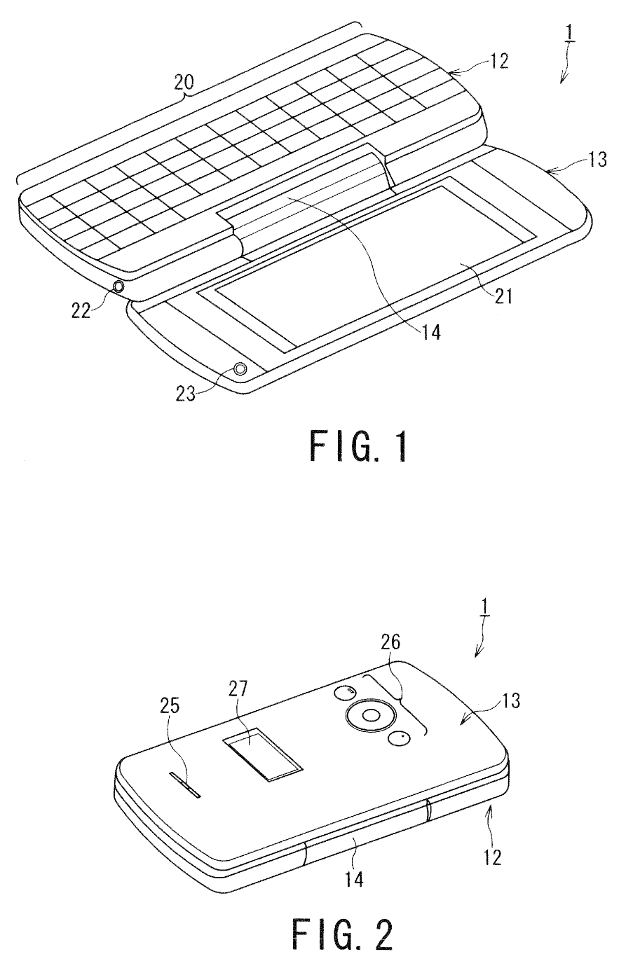

FIG. 1 is an external perspective view of the portable terminal device according to the present invention, showing an opened stare of the device.

A portable terminal device 1 includes a first casing 12 and a second casing 13 that are formed in substantially the same rectangular shape. The first casing 12 and the second casing 13 are rotatably connected together via a hinge mechanism 14. FIG. 1 shows the portable terminal device 1 in a state that main operating keys 20 provided on the first casing 12 and a main display 21 provided on the second casing 13 are accessibly exposed. This state is referred to “an opened state” below.

At a predetermined position inside the portable terminal device 1, a sending/receiving antenna (not shown) is provided. In the portable terminal device 1, radio waves are sent and received via a base station by the antenna built in the portable terminal device 1 so as to establish voice communications and data communications.

On the first casing 12, the main operating keys 20 are provided for serving as first input receiving unit to receive an input when the portable terminal device 1 is opened to expose the main operating keys 20. The main operating keys 20 are provided with a plurality of keys, such as keys allocated for inputting digits “0” to “9” and keys allocated for inputting alphabets “A” to “Z”, so that various instructions can be inputted by pushing down the main operating keys 20.

The first casing 12 is provided with a microphone and a receiver (both not shown) for voice communicating in the opened state. At a predetermined position of the portable terminal device 1, a speaker (not shown) is also provided for serving as voice output units including the receiver.

The first casing 12 is provided with a battery pack (not shown) insertable into the casing from the rear side. When a power supply key 22 is pushed to turn on the battery, electric power is supplied to each circuit from the battery pack to actuate the portable terminal device 1 in an active state.

On the rear side of the first casing 12, an external CCD camera (not shown) is provided, thereby imaging a desired object.

On the other hand, the main display 21 is provided on the second casing 13 to turn on when the portable terminal device 1 is opened to expose the main display 21. The main display 21 is configured of a display such as a LCD (liquid crystal display), an organic EL (electroluminescence) display, an inorganic EL display, and a SED (surface-conduction electron-emitter display).

On the main display 21, displayed are a radio wave receiving state, battery residual power, names and telephone numbers which are enrolled as the telephone directory, sending histories on the other end of the line, moving images, contents of electronic mails, simple Web pages, and documents, for example. When communicating using a TV phone function, moving images of a person on the other end are also displayed thereon.

When the portable terminal device 1 is shifted from the closed state to the opened state, or when the main operating keys 20 receives some kind of input, the main display 21 is to be shifted from the turning-off state to the turning-on state. When the turned-on main display 21 is not operated for a predetermined period of time, the main display 21 is to be shifted to the turning-off state.

The main display 21 also serves as first, inputting unit having a tablet function to receive an input using a stylus input device (not shown).

The second casing 13 is provided with an internal CCD camera 23, thereby imaging a desired object. When communicating using the TV phone function, images to be sent to the other end are also picked up.

FIG. 2 is an external perspective view of a portable terminal device 1 according to the present invention, showing a closed state of the device.

FIG. 2 shows the portable terminal device 1 in a state that the first casing 12 and the second casing 13 are rotated from the opened state shown in FIG. 1 in the closing direction such that the main operating keys 20 is substantially overlapped with the main display 21 to oppose each other. This state is referred to “a closed state” below.

The second casing 13 is provided with a microphone (not shown) and a receiver 23 for voice communicating in the closed state in the same way as in the opened state.

On the second casing 13, sub-operating keys 26 are provided for serving as second input receiving unit to receive an input when the portable terminal device 1 is closed to expose the sub-operating keys 26. The sub-operating keys 26 are provided with keys, such as a cross key and an enter key, so that various processes, which are executable even the portable terminal device 1 is closed, are allocated for these keys.

The second casing 13 is provided with a sub-display 27 composed of a LCD, for example. On the sub-display 27, a pictorial antenna showing the present antenna sensitivity level, a pictorial battery showing the residual power of the battery, and the present time are displayed. On the sub-display 27, alphabetic information and icons may also be displayed appropriately on demand for informing the arrival of the voice communication and the TV phone or the new arrival of electronic mails.

The sub-display 27 also has the tablet function to receive an input using the stylus input device (not shown), also serving as second input, receiving unit. On the sub-display 27, digits “0” to “9” and symbols “*” and “#” are displayed. When the sub-display 27 is touched using the stylus input device, the digit displayed at the position where being touched is received as an input.

When the sub-display 27 and the sub-operating keys 26 receive a predetermined input, various processes can be executed even in the closed state of the portable terminal device 1. For example, by pushing down a predetermined sub-operating key 26, the music reproducing application, the confirmation screen of the electronic mails, the external CCD camera, the alarm setting function, or the sending voice communication can be actuated. The sub-display 27 is also to receive the sending telephone number of the voice communication and the input of a password for canceling a main-display turning-on lock function provided in the portable terminal device 1 according to the embodiment.

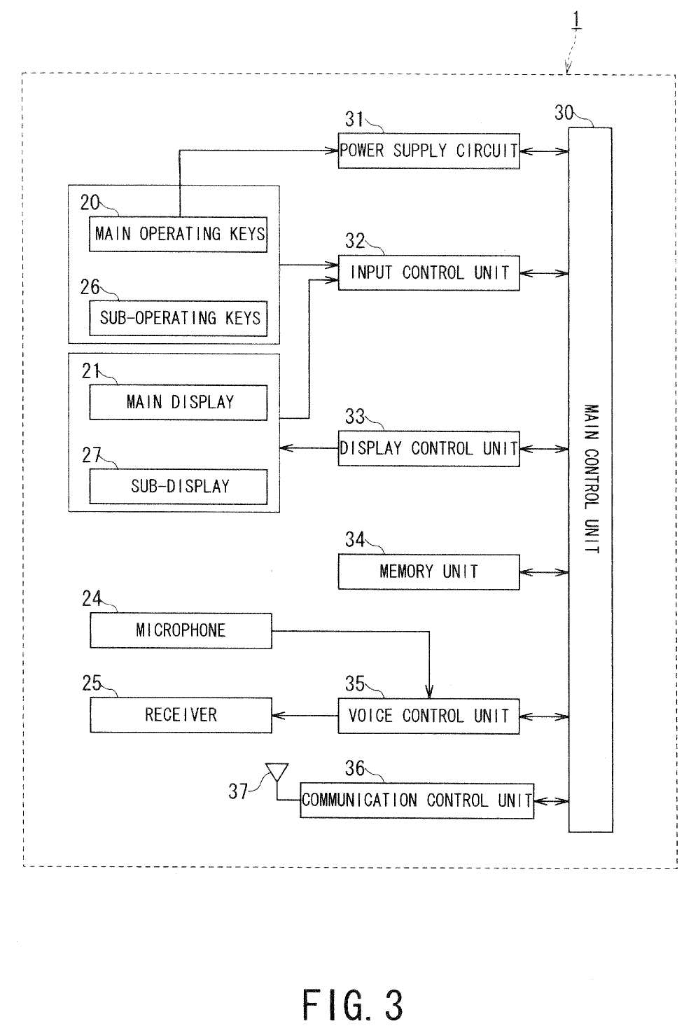

FIG. 3 is a drawing showing the internal configuration of the portable terminal device 1 according to the embodiment.

The portable terminal device 1 includes a main control unit 30, a power supply circuit 31, an input control unit 32, a display control unit 33, a memory unit 34, a voice control unit 35, and a communication control unit 36 connected together to be able to communicate with each other.

The main control unit 30 includes a CPU (central processing unit). The CPU controls the portable terminal device 1 as a whole by producing various control signals to supply them to each unit. The CPU executes input, control processing for inputs received from the main operating keys 20 and the sub-operating keys 26, and other various kinds of processing, such as arithmetic processing and control processing.

The power supply circuit 31 switches the power supply on and off based on the input received from the power supply key 22 pushed by a user. The power supply circuit 31 supplies electric power to each circuit from the battery pack so as to actuate the portable terminal device 1 in an active state when the power supply is turned on.

The input control unit 32 includes input interfaces to the main operating keys 20, the sub-operating keys 26, the main display 21, and the sub-display 27. When the push down of a main operating key 20 is detected, the input control unit 32 produces the signal of the pushed down key to supply the signal to the main control unit 30. According to the embodiment, when the instruction of the main display turning-on lock setting is received, the input control unit 32 serves as input controlling unit for controlling the input received from the main operating key 20 on the basis of the instruction by the main control unit 30.

The display control unit 33, including display interfaces to the main display 21 and the sub-display 27, controls the turning-on state of the main display 21 and displays the display information including documents and moving images on the main display 21 and the sub-display 27 based on the control by the main control unit 30. According to the embodiment, when the instruction of the main display turning-on lock setting or canceling is received, the display control unit 33 serves as turning-on locking unit or lock canceling unit for having the turning-on possible state or the turning-on impossible state by controlling the main display 21 based on the instruction from the main control unit 30.

The memory unit 34 includes an ROM (read only memory), a hard disk, a non-volatile memory for storing processing programs for the process executed by the main control unit 30 and data required for the processing, and an RAM (random access memory) for temporarily storing data used when the main control unit 30 executes the processes. The memory unit 34 stores various applications, such as an electronic mail function executed by the CPU of the main control unit 30, and various data groups.

The voice control unit 35 produces an analog voice signal from a voice collected by a microphone 24, and converts the analog voice signal into a digital voice signal on the basis of the control by the main control unit 30. When the voice control unit 35 obtains the digital voice signal the voice control unit 35 converts the digital voice signal into an analog voice signal so as to output the analog voice signal as a voice from the receiver 25 on the basis of the control by the main control unit 30.

The communication control unit 36 restores data by the spectrum de-spreading processing on the signal received from the base station (not shown) via an antenna 37 on the basis of the control by the main control unit 30. With the instructions by the main control unit 30, the data is transmitted to the voice control unit 35 and outputted from the receiver 25; is transmitted to the display control unit 33 and displayed on the main display 21; or is stored in the memory unit 34. The communication control unit 36 obtains the voice data collected by the microphone 24, the data inputted via the main operating keys 20, and the data stored in the memory unit 34; then, performs the spreading spectrum processing on these data for sending the data to the base station via the antennal 37 on the basis of the control by the main control unit 30.

In a conventional portable terminal device, a lock function has been provided for invalidating the operation received from an operating key in order to prevent a third party from abusing the device and the accidental improper operation generated when storing the device in a bag, for example.

In the conventional portable terminal device herein, there are a lock function invalidating all the operations received by the portable terminal device and a lock function limiting the execution of part of the functions. For canceling these lock functions, a password established in advance is to input via operating keys when an input screen for the password is displayed on the main display. Alternatively, the lock function is cancelled by long pushing a specific operating key.

In recent portable terminal devices, increasing devices have multiple functions of not only voice communication but also data communication, picking up moving images, moving audio-visual functions, and access to documents and images. Along with this, the level of importance is increased in security enhancement against the abuse of a third party and control of the information contained within the device.

In the portable terminal device 1 according to the embodiment, by adding the control process on the turning-on state of the main display 21 to these lock functions, there is provided a main-display turning-on lock function that improves the degree of security while maintaining the operationality for various functions using the sub-display 27 and the sub-operating keys 26 in the closed state.

The processes executed when setting the main-display turning-on lock function of the portable terminal device 1 according to the embodiment will be described.

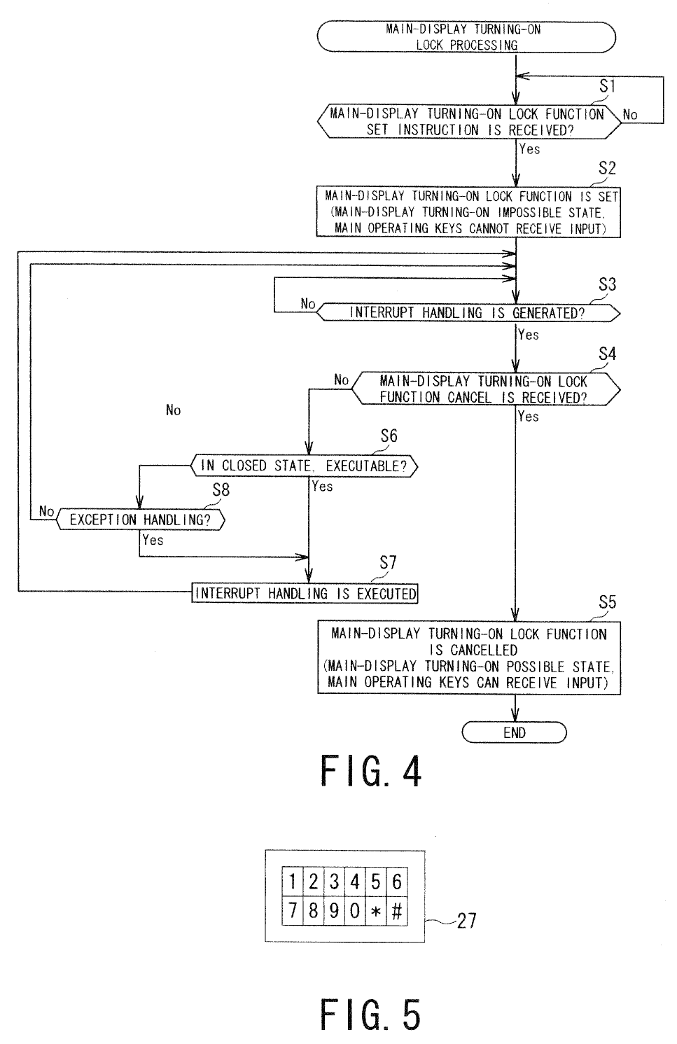

FIG. 4 is a flowchart of the main-display turning-on lock process to be executed in the portable terminal device 1 according to the embodiment.

At Step S1, the main control unit 30 determines whether the instruction to set the main-display turning-on lock function is received or not. The main-display turning-on lock function is set by receiving the instruction input via the main operating keys 20 from the setting screen for the main-display turning-on lock function displayed on the main display 21. Alternatively, the main-display turning-on lock function may be set by receiving a predetermined input via the sub-operating keys 26 or the sub-display 27.

When the main control unit 30 determines that the instruction is not received, the processing for the setting is waited until receiving the instruction.

When the main control unit 30 determines that the instruction is received, at Step S2, the main-display turning-on lock function is set.

The display control unit 33 makes the main display 21 the turning-on impossible state by controlling the main display 21 on the basis of the instruction by the main control unit 30. The turning-on impossible state means a state of the main display 21 maintaining the turning-off state without shifting to the turning-on state even when the portable terminal device 1 is shifted from the closed state to the opened state, or even when the main operating keys 20 receive some kind of input. Whereas, the turning-on possible state means a state that can shift from the turning-off state to the turning-on state when the portable terminal device 1 is shifted from the closed state to the opened state, or the main operating keys 20 receive some kind of input.

The input control unit 32 invalidates the input received by the main operating keys 20 and the main display 21 on the basis of the instruction by the main control unit 30. By invalidating the input received by the main operating keys 20, etc., the execution of the processing can be prevented even when the processing is inputted intentionally or due to incorrect operation regardless of the turning-on impossible states of the main display 21.

At lock setting Step S2, the sub-display 27 is in a state that can appropriately turn-on, and the sub-operating keys 26 and the sub-display 27 are in a state that can appropriately receive the input. Hence, there is no limit of any kind in executing the processing of the portable terminal device 1 that is operable using the sub-display 27 and the sub-operating keys 26.

At Step S3, the main control unit 30 determines whether an interrupt handling is generated in the portable terminal device 1.

The interrupt handling is generated when the portable terminal device 1 is shifted from the closed state to the opened state; when the voice communication or the TV phone comes; when the electronic mail newly arrives; or when the sub-display 27 receives any kind of input such as a password for canceling the main-display turning-on lock function, for example.

When the main control unit 30 determines that the interrupt handling is not generated in the portable terminal device 1, the processing is waited until the interrupt handling is generated.

On the other hand, when the main control unit 30 determines that the interrupt handling is generated in the portable terminal device 1, at Step S4, the main control unit 30 determines whether the instruction for canceling the main-display turning-on lock function is received due to the generated interrupt handling. The instruction for canceling the main-display turning-on lock function is to be received by entering a password established, in advance via the sub-display 27 as second input receiving unit. This password is produced with the combination of a predetermined number of digits or symbols, established by a user in advance and is stored in the memory unit 34. The password may be appropriately changed.

FIG. 5 is a drawing showing a display example on the sub-display 27 of the portable terminal device 1 according to the embodiment.

By pushing down a predetermined sub-operating key 26, or by touching the sub-display 27 with a tablet function using a stylus input device, digits “0” to “9” and symbols “*” and “#” are displayed on the sub-display 27 as shown in FIG. 5. By touching the sub-display 27 using the stylus input device, the sub-display 27 receives the digit, etc., displayed at the pushed position.

It is preferable that the password be composed of digits and symbols, which is not misidentified as the telephone number on the other end during the voice communication. For example, when receiving the input of a six-digit combination of digit and symbol, such as “#1289#”, which is not misidentified as the telephone number, the main control unit 30 may recognize the receiving the input of the password.

When the main control unit 30 receives the input of the password established in advance from the sub-display 27, the receiving the instruction for canceling the main-display turning-on lock function is recognized. On the other hand, if the sub-display 27 receives an incorrect password different from the password established in advance, the main control unit 30 informs a user that the password is incorrect by displaying that on the sub-display 27.

At lock-cancel determining Step S4, the portable terminal device 1 is in a closed state capable of displaying images on the sub-display 27 and of receiving the input onto the sub-display 27 and the sub-operating keys 26.

When the main control unit 30 determines that the instruction for canceling the main display turning-on lock function is received, at Step S5, the main control unit 30 cancels the main-display turning-on lock function.

The display control unit 33 completes the turning-on impossible state of the main display 21 started at lock setting Step S2 so as to shift the state to the turning-on possible state on the basis of the instruction by the main control unit 30. The input control unit 32 enables the input onto the main operating keys 20 and the main display 21, which has been invalidated at lock setting Step S2, to be received so as to complete the main display turning-on lock processing on the basis of the instruction by the main control unit 30.

When the main control unit 30 determines no receive of the instruction for canceling the main-display turning-on lock function, at Step S6, the main control unit 30 determines whether the interrupt handling generated at interrupt handling determining Step S3 is executable or not even the portable terminal device 1 is in the closed state.

In the portable terminal device 1 according to the embodiment, when the sub-display 27 and the sub-operating keys 26 receive a predetermined input, various kinds of processing can be executed even the portable terminal device 1 is in the closed state. For example, by pushing down a predetermined sub-operating key 26, the music reproducing application, the confirmation screen of the electronic mails, the external CCD camera, the alarm setting function, or the sending voice communication can be actuated. On the sub-display 27, digits and symbols are displayed as shown in FIG. 5, and the sub-display 27 is to receive the sending telephone number of the voice communication, etc.

When the interrupt handling generated in the portable terminal device 1 is an operable kind of processing even in the closed state, at Step S7, the main control unit 30 executes the interrupt handling. For example, if the handling is the incoming voice communication, the main control unit 30 executes the voice communication by controlling the communication control unit 36 and the voice control unit 35.

On the other hand, if the interrupt handling generated in the portable terminal device 1 is an inoperable kind of processing in the closed state, at Step S8, the main control unit 30 determines whether the generated interrupt handling is the exception handling established in advance or not.

The exception handling among the interrupt handlings is the processing being indispensable to use the main display 21 for execution of the handling. Hence, during the execution of the exception handling, the main-display turning-on lock function is temporarily cancelled so that the main display 21 is sniffed to the turning-on possible state.

An example of the exception handling includes the processing for the incoming TV phone. The TV phone function is to communicate with the other-end person while displaying moving images of the person on the main display 21, or to communicate therewith while sending own moving images picked up using the internal CCD camera 23 to the other-end person. Hence, when the incoming TV phone processing is generated, it is necessary to actuate the internal CCD camera 23 and to use the main display 21 for displaying the photographic data picked up by the internal CCD camera 23 and received from the other-end person by shifting the portable terminal device 1 to the opened state. Such processing is treated as the exception handling; so that moving images of the other-end person are displayed on the main display 21 by temporarily canceling the main-display turning-on lock function.

The incoming TV phone processing has been exemplified as the exception handling; however, the handling is not limited to this so that another processing may be treated or a user may optionally set an exception handling.

When the main control unit 30 determines that the generated interrupt handling is the exception handling established in advance at exception handling determining Step S8, the process proceeds to interrupt handling executing Step S7 so as to execute the generated interrupt handling. At this time, the display control unit 33 temporarily cancels the main-display turning-on lock function for shifting the main display 21 to the turning-on possible state by controlling the main display 21 on the basis of the instruction by the main control unit 30. The input control unit 32 enables the input received by the main operating keys 20 to be temporarily effective for receiving the interrupt handling input on the basis of the instruction by the main control unit 30.

On the other hand, when the main control unit 30 determines that the generated interrupt handling is not the exception handling established in advance, the process returns to interrupt handling determining Step S3 so as to repeat the subsequent processing.

That is the description of the main-display turning-on lock processing.

According to the portable terminal device 1, when the main-display turning-on lock function is established, even if the portable terminal device 1 is shifted to the opened state, the main display 21 is not turned-on, so that the abuse by a third party can be suppressed.

Of the input processing received by the sub-display 27 and the sub-operating keys 26, since various simple operations are maintained, the operationality is ensured for a user. On the other hand, when the portable terminal device 1 is shifted to the opened state, various advanced functions are provided and highly secret information is contained inside in comparison with the functions executed using the sub-display 27. Along with this, when the portable terminal device 1 is shifted to the opened state, the degree of security can also be improved against the abuse of a third party and for controlling the information contained within the portable terminal device 1.

Furthermore, since the main display 21 is not turned-on to display no images, a third party only seeing the main display 21 cannot recognize the execution of the lock function. Therefore, the abuse by advisedly entering the password via the main display 21 and the main operating keys can be suppressed, thereby improving the degree of security.

Then, the processing executed when the main-display turning-on lock function and the key lock function of the portable terminal device 1 according to the embodiment are simultaneously established will be described.

The key lock function is to limit the inputs received by the main operating keys 20, the sub-operating keys 26, and the main display 21/the sub-display 27 having the tablet function. The key lock function can be cancelled by entering a password, for example, and is provided for preventing the abuse by a third party.

According to the embodiment, by simultaneously establishing the main-display turning-on lock function and the key lock function provided in the portable terminal device 1, the degree of security can be more improved.

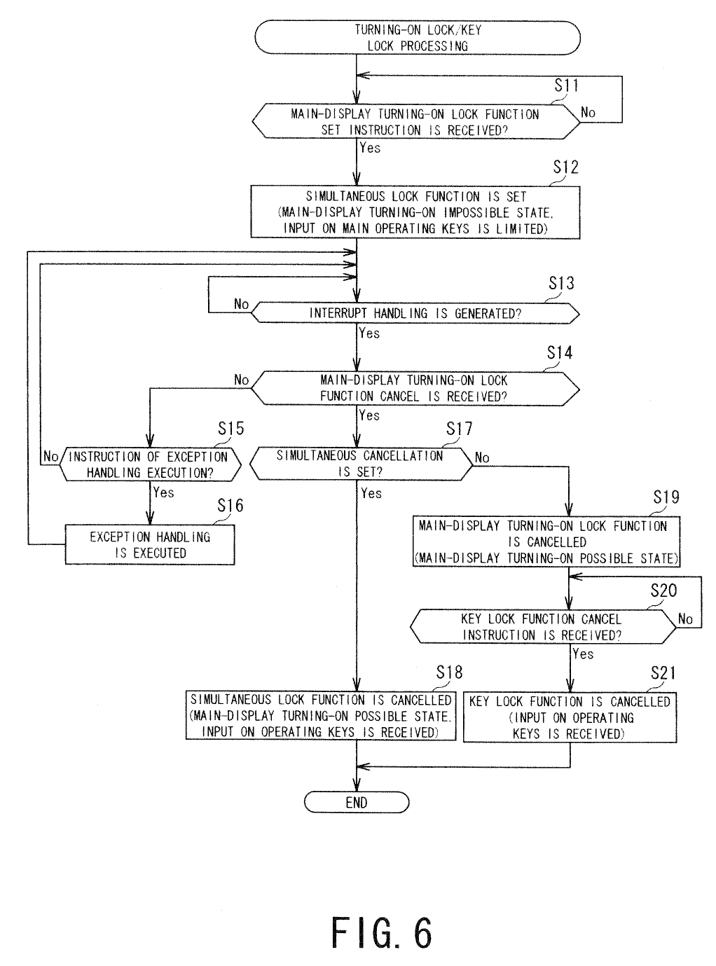

FIG. 6 is a flowchart of the turning-on lock/key lock process to be executed in the portable terminal device 1 according to the embodiment. When the main-display turning-on lock function and the key lock function are simultaneously established, these functions are referred to a simultaneous lock function below for the description convenience sake.

At Step S11, the main control unit 30 determines whether the instruction for setting the main-display turning-on lock function is received or not. The main-display turning-on lock function is established due to the receiving the input instruction for setting the main-display turning-on lock function from the screen displayed on the main display 21 for setting the main-display turning-on lock function by the main operating keys 20.

Whether the setting of the key lock function is received at the same time the instruction for setting the main-display turning-on lock function is received at set receive determining Step S11 may also be optionally established by a user in advance.

When the main control unit 30 determines that the instruction for setting the main-display turning-on lock function is not received, the processing is waited until receiving the instruction.

When the main control unit 30 determines that the instruction for setting the main-display turning-on lock function is received, the main control unit 30 sets the simultaneous lock function at Step S12.

The display control unit 33 shifts the main display 21 to the turning-on impossible state on the basis of the instruction by the main control unit 30. Also, the input control unit 32, on the basis of the instruction by the main control unit 30, limits the inputs received by the main operating keys 20, the sub-operating keys 26, and the main display 21/the sub-display 27 having the tablet function so as to invalidate received inputs other than predetermined inputs.

At lock setting Step S12, the sub-display 27 can appropriately be turned-on and the sub-operating keys 26 and the sub-display 27 can receive limited inputs such as the input of the password for canceling the simultaneous lock function.

Since interrupt handling determining Step S13 and lock cancel determining Step S14 are substantially the same as interrupt handling determining Step S3 and lock cancel determining Step S4, respectively, in the main-display turning-on lock processing described in FIG. 4, the detailed description is omitted.

When the main control unit 30 determines that the instruction for canceling the main-display turning-on lock function is not received, at Step S15, the main control unit 30 determines whether the interrupt handling generated at interrupt handling determining Step S13 is the input instruction for executing the interrupt handling established in advance even the simultaneous lock function has been set. The interrupt handling in the turning-on lock/key lock process can be executed only when receiving a specific input set in advance. For improving the degree of security, it is preferable that unit for receiving a specific input be optionally set by a user.

The exception handling that can be exceptionally executed includes an emergency voice call required at an emergency for example. The instruction for executing the exception handling can be operated in the closed state shown in FIG. 2. By long pushing a specific key of the sub-operating keys 26 allocated to execute the exception handling, or by simultaneously long pushing a plurality of the sub-operating keys 26, the instruction for executing the exception handling is received.

When the main control unit 30 determines that the generated interrupt handling is the instruction for executing the exception handling established in advance at exception handling determining Step S15, the exception handling is executed at Step S16. The input control unit 32 enables the input received by the sub-display 27 to be temporarily effective, so that the entering the emergency telephone number is received, for example on the basis of the control by the main control unit 30. At this time, on the sub-display 27, digits and symbols are displayed as shown in FIG. 5, and from, which, the emergency telephone number is to be received. After receiving the telephone number, the main control unit 30 executes the emergency voice call processing as an exception handling.

When a telephone number other than the emergency telephone number stored in the memory unit 34 of the portable terminal device 1 in advance is entered, by invalidating the input, the degree of security can be further improved. In the exception handling, optional processing may also be set by a user.

On the other hand, when the main control unit 30 determines that the generated interrupt handling is not the exception handling established in advance, the process returns to interrupt, handling determining Step S13 so as to repeat the subsequent processing. The cases where the generated interrupt handling is not the exception handling established in advance include the case where the portable terminal device 1 is shifted from the closed state to the opened state; the case where the main operating keys 20 receive some kind of input; the case of the arrival of the voice communication or the TV telephone; and the case of the new arrival of the electronic mail.

At this time, in the case of the arrival of the voice communication or the TV telephone and the case of the new arrival of the electronic mail, the informing processing itself, such as the ringing output from the speaker and the displaying on the sub-display 27, may not be performed.

At lock cancel determining Step S14, when the main control unit 30 determines that the instruction for canceling the main-display turning-on lock function is received, the main control unit 30 determines whether the simultaneous canceling of the key lock function simultaneously set wish the main-display turning-on lock function has been established or not at Step S17.

In the simultaneous lock function, the determination, whether the lock function receives the canceling at the same time the main-display turning-on lock function receives the canceling can be optionally set by a user in advance. The determination whether the canceling the key lock function is simultaneously received or not may also be set in advance.

When the main control unit 30 determines that the key lock function has been set at the simultaneous canceling, the simultaneous lock function is cancelled at Step S18.

The display control unit 33 completes the turning-on impossible state of the main display 21 started at lock set Step S12 so as to shift the state to the turning-on possible state on the basis of the instruction by the main control unit 30. Also, the input control unit 32, on the basis of the instruction by the main control unit 30, cancels the limitation of the receiving from the main operating keys 20, the sub-operating keys 26, and the main display 21/the sub-display 27 having the tablet function limited at lock set Step S12 so as to be effective in receiving the inputs for completing the turning-on lock/key lock processing.

On the other hand, when the main control unit 30 determines that the key lock function set simultaneously with the main-display turning-on lock function has not been set at the simultaneous canceling, only the main-display turning-on lock function is cancelled at Step S19.

The display control unit 33, on the basis of the instruction by the main control unit 30, completes the turning-on impossible state of the main display 21 started at lock set Step S12 so as to shift the state to the turning-on possible state. The input control unit 32 continues to limit inputs received from the main operating keys 20, the sub-operating keys 26, and the main display 21/the sub-display 27 having the tablet function so as to invalidate the inputs other than predetermined inputs.

At this time, since the main display 21 is in the turning-on possible state, a password input screen for receiving the cancellation of the key lock function is displayed on the main display 21, for example. In order to enable the cancellation of the key lock function to be received even in the opened state, the main operating keys 20 are configured to receive only the input of the password.

At Step S20, the main control unit 30 determines whether the instruction for canceling the key lock function is received or not.

The instruction for canceling the key lock function is received by entering a password established via the sub-display 27 and the main operating keys 20 in advance in the same way as in the instruction for canceling the main-display turning-on lock function. The password is composed of the combination of arbitrary digits and symbols established by a user in advance, and stored in the memory unit 34. It is preferable that the password is different from that used for canceling the main-display turning-on lock function, and it may be appropriately changed.

When the input of the password established in advance is received from the sub-display 27 or the main operating keys 20, the main control unit 30 recognizes the received input as being the instruction for canceling the key lock function. On the other hand, if the input of an incorrect password composed of digits or symbols different from those established in advance is received, the main control unit 30 informs a user of the incorrect password by displaying it on the sub-display 27 or the main display 21.

When the main control unit 30 determines that the instruction for canceling the key lock function is not received, the processing is waited until receiving the instruction for canceling the key lock function.

When the main control unit 30 determines that the instruction for canceling the key lock function is received, the key lock function is cancelled at Step S21.

The input control unit 32, on the basis of the instruction by the main control unit 30, validates the input received from the main operating keys 20, which has been ineffectively limited since lock set Step S12, so as to complete the turning-on lock/key lock processing.

That is the description of the turning-on lock/key lock processing.

According to the portable terminal device 1, the preexisting key lock function and the main-display turning-on lock function are simultaneously established, so that the degree of security can be further improved.

Namely, entering an individual password is demanded for the instruction for canceling the lock function without simultaneously canceling the simultaneous lock function, so that a double lock function composed of the main-display turning-on lock function and the key lock function can be established. Since the main-display turning-on lock function is established at this time, the main display 21 is not turned-on to have no display, so that a seeing third party cannot recognize the execution of the lock function. Hence, the abuse by purposely entering a password via the main display 21 and the main operating keys 20, for example, can be suppressed, thereby improving the degree of security.

Furthermore, the instruction of simultaneous canceling of the simultaneous lock function is to be received by the sub-display 27, which is operative even in the closed state of the portable terminal device 1, so that the degree of security as well as user operationality can be improved because the canceling instruction input can be received without shifting the key lock function to an opened stare.

According to the embodiment, the sub-display 27 is used as the second input receiving unit; the invention is not limited to this, so that the instruction for canceling the main-display turning-on lock function may be received only from the sub-operating keys 26; or a finger print identifying function operative in the closed state may be provided, and the canceling instruction may be received only when a user's finger print is identified.

In the turning-on lock/key lock processing, the key lock function simultaneously established with the main-display turning-on lock function is exemplified; alternatively, a function locking only a specific function may be set at the same time. For example, a lock function for suppressing the abuse by a third party of the voice communication function, the address book, the incoming history, the outgoing history, and access to electronic mails.

Furthermore, in the portable terminal device according to the embodiment, the foldable portable terminal device has been exemplified; alternatively, a portable terminal device having one display and a plurality of input receiving unit incorporated.

The portable terminal device according to the present invention may be incorporated in a mobile phone, a PDA (personal digital assistant), a personal computer, a portable game machine, a portable music reproducing device, a portable moving image reproducing device, and other portable terminal devices information processing apparatus.

What is claimed is:

1. A portable terminal device, comprising:
a first casing;
a second casing connected rotatably with the first casing to have an opened state and a closed state;
a first input receiving unit provided in the first casing to receive an input if the portable terminal device is the opened state to expose the first input receiving unit;
a first displaying unit provided in the second casing to be turned-on if the portable terminal device is the opened state to expose the first displaying unit;
a second input receiving unit provided in the first casing or the second casing to receive an input if the portable terminal device is the closed state to expose the second input receiving unit;
a turning-on lock unit for controlling the first displaying unit in a turning-on impossible state on the basis of a lock set instruction input received by the first input receiving unit or the second input receiving unit; and
a lock canceling unit for controlling the first displaying unit in a turning-on possible state on the basis of a lock cancel instruction input received by the second input receiving unit if the first displaying unit is controlled in the turning-on impossible state by the turning-on lock unit.

2. The portable terminal device according to claim 1, further comprising an input controlling unit that validates inputs received by the second input receiving unit while invalidating inputs received by the first input receiving unit, if the first displaying unit is controlled in the turning-on impossible state by the turning-on lock unit.

3. The portable terminal device according to claim 1, wherein the lock canceling unit temporarily controls the first displaying unit in the turning-on possible state if a generated interrupt handling is an exception handling established in advance when the first displaying unit is controlled in the turning-on impossible state by the turning-on lock unit.

4. The portable terminal device according to claim 1, further comprising an input controlling unit that invalidates inputs received by the first input receiving unit and the second input receiving unit other than predetermined inputs at the same time if the first displaying unit is controlled in the turning-on impossible state by the turning-on lock unit.

5. The portable terminal device according to claim 4, wherein the input controlling unit validates inputs received by the first input receiving unit and the second input receiving unit if the input of the lock cancel instruction, which is one of the predetermined inputs, is received by the second input receiving unit.

6. The portable terminal device according to claim 4, wherein the input controlling unit continues to invalidate inputs received by the first input receiving unit and the second input receiving unit other than the predetermined inputs if the input of the lock cancel instruction, which is one of the predetermined inputs, is received by the second input receiving unit.

7. The portable terminal device according to claim 4, wherein the input controlling unit temporarily validates the input received by the second input receiving unit inputted along with the execution of an exception handling established in advance if the second input receiving unit receives the predetermined input allocated for executing the exception handling.

8. The portable terminal device according to claim 7, wherein the exception handling is emergency voice-outgoing processing.

9. The portable terminal device according to claim 1, wherein the second input receiving unit receives an input of digits or symbols, and
the lock canceling unit recognizes the received input as being an input regarding to a password that is the lock cancel instruction if the input of a predetermined number of digits or symbols established in advance is received from the second input receiving unit.

10. An information processing apparatus, comprising:
a first casing;
a second casing which is hinge-connected to the first casing via a hinge part;
a first input receiving unit provided in the first casing to receive an input if the portable terminal device is the opened state to expose the first input receiving unit;
a first displaying unit provided in the second casing to be turned-on if the information processing apparatus is the opened state to expose the first displaying unit;
a second input receiving unit provided in the first casing or the second casing to receive an input if the information processing apparatus is the closed state to expose the second input receiving unit;
a turning-on lock unit for controlling the first displaying unit in a turning-on impossible state on the basis of a lock set instruction input received by the first input receiving unit or the second input receiving unit; and
a lock canceling unit for controlling the first displaying unit in a turning-on possible state on the basis of a lock cancel instruction input received by the second input receiving unit if the first displaying unit is controlled in the turning-on impossible state by the turning-on lock unit.

11. The information processing apparatus according to claim 10, further comprising an input controlling unit that, validates inputs received by the second input receiving unit while invalidating inputs received by the first input receiving unit, if the first displaying unit is controlled in the turning-on impossible state by the turning-on lock unit.

12. The information processing apparatus according to claim 10, wherein the lock canceling unit temporarily controls the first displaying unit in the turning-on possible state if a generated interrupt handling is an exception handling established in advance when the first displaying unit is controlled in the turning-on impossible state by the turning-on lock unit.

13. The information processing apparatus according to Claim 10, further comprising an input controlling unit that invalidates inputs received by the first input receiving unit and the second input receiving unit other than predetermined inputs at the same time if the first displaying unit is controlled in the turning-on impossible state by the turning-on lock unit.

14. The information processing apparatus according to claim 13, wherein the input controlling unit validates inputs received by the first input receiving unit and the second input receiving unit if the input of the lock cancel instruction, which is one of the predetermined inputs, is received by the second input receiving unit.

15. The information processing apparatus according to claim 13, wherein the input controlling unit continues to invalidate inputs received by the first input receiving unit and the second input receiving unit other than the predetermined inputs if the input of the lock cancel instruction, which is one of the predetermined inputs, is received by the second input receiving unit.

16. The information processing apparatus according to claim 13, wherein the input controlling unit temporarily validates the input received by the second input receiving unit inputted along with the execution of an exception handling established in advance if the second input receiving unit receives the predetermined input allocated for executing the exception handling.

17. The information processing apparatus according to claim 16, wherein the exception handling is emergency voice-outgoing processing.

18. The information processing apparatus according to claim 10, wherein the second input receiving unit receives an input of digits or symbols, and
the lock canceling unit recognizes the received input as being an input regarding to a password that is the lock cancel instruction if the input of a predetermined number of digits or symbols established in advance is received from the second input receiving unit.
